(19) United States
(12) Patent Application Publication
(10) Pub. No.: US 2026/0111330 A1
(43) Pub. Date: Apr. 23, 2026

(54) MONITORING SYSTEM, MONITORING METHOD AND NON-TRANSITORY COMPUTER READABLE STORAGE MEDIUM

(71) Applicant: Rakuten Asia Pte. Ltd., Singapore (SG)

(72) Inventor: Saravana Kumar UMAPATHY, Singapore (SG)

(73) Assignee: Rakuten Asia Pte. Ltd., Singapore (SG)

(21) Appl. No.: 18/985,378

(22) Filed: Dec. 18, 2024

(30) Foreign Application Priority Data
Oct. 23, 2024 (JP) 2024-186442

(51) Int. Cl. G06F 11/34; G06F 16/27

(52) U.S. Cl. CPC G06F 11/3419; G06F 16/27; G06F 2201/80

(57) ABSTRACT

A monitoring system configured to: acquire a plurality of first values corresponding to a plurality of target time points included in a monitoring period respectively, each first value indicating a representative value of a lag in replication from a primary database to a secondary database in a first period including the corresponding target time point; acquire a plurality of second values corresponding to the plurality of target time points respectively, each second value indicating a representative value of the lag in replication in a second period which includes the corresponding target time point and which is longer than the first period; and output an alert relating to replication when, among the plurality of target time points, a counted number of target time points having a larger corresponding first value than a corresponding second value satisfies an anomaly detection condition.

### CROSS-REFERENCE TO RELATED APPLICATION

The present application claims priority from Japanese application JP 2024-186442 filed on Oct. 23, 2024, the content of which is hereby incorporated by reference into this application.

### BACKGROUND

### 1. Field

The present disclosure relates to a monitoring system, a monitoring method, and a computer readable medium storing a program.

### 2. Description of the Related Art

There are systems which synchronize (this is also referred to as “replicate”) data among a plurality of databases, and use the synchronized databases. When a system replicates from a primary database to a secondary database, the replication can cause a lag in writing data. When this lag becomes large, a problem may arise in the provision of a service. Further, database synchronization may affect data consistency due to, for example, the reading of data before synchronization.

In order to respond to such problems promptly, there are technologies for monitoring a system's operating status.

In monitoring database replication, many factors relating to the operating environment (e.g., application configuration and network) affect performance. As a result, for example, it is not easy to detect an anomaly with high accuracy, and there can be uncertainty that an anomaly in the replication may not be adequately handled.

### SUMMARY

An object of the present disclosure is to provide a technology for detecting an anomaly in a system more appropriately.
(1) There is provided a monitoring system configured to: acquire a plurality of first values corresponding to a plurality of target time points included in a monitoring period respectively, each of the plurality of first values indicating a representative value of a lag in replication from a primary database to a secondary database in a first period including the corresponding one of the plurality of target time points; acquire a plurality of second values corresponding to the plurality of target time points respectively, each of the plurality of second values indicating a representative value of the lag in replication in a second period which includes the corresponding one of the plurality of target time points and which is longer than the first period; and output an alert relating to replication when, among the plurality of target time points, a counted number of target time points having a larger corresponding first value than a corresponding second value satisfies an anomaly detection condition.
(2) In the monitoring system according to Item (1), the plurality of first values may each indicate a moving average of the lag in replication in the first period including the corresponding one of the plurality of target time points, and the plurality of second values may each indicate a moving average of the lag in replication in the second period including the corresponding one of the plurality of target time points.
(3) In the monitoring system according to Item (1) or (2), the lag in replication may be a time period from when information is written to the primary database until the information is written to the secondary database.
(4) In the monitoring system according to any one of Items (1) to (3), each of the plurality of target time points may be closer to an end of a corresponding second period than to a start of the corresponding second period.
(5) In the monitoring system according to any one of Items (1) to (4), the monitoring system may be configured to output the alert relating to replication when the counted number of the target time points is larger than a threshold value corresponding to the number of target time points.
(6) In the monitoring system according to Item (5), the threshold value may be determined by multiplying the number of the plurality of target time points by a predetermined ratio.
(7) In the monitoring system according to any one of Items (1) to (6), the monitoring system may be configured to output the alert relating to replication to an administrator when the anomaly detection condition is satisfied.
(8) There is provided a monitoring method including: acquiring a plurality of first values corresponding to a plurality of target time points included in a monitoring period respectively, each of the plurality of first values indicating a representative value of a lag in replication from a primary database to a secondary database in a first period including the corresponding one of the plurality of target time points; acquiring a plurality of second values corresponding to the plurality of target time points respectively, each of the plurality of second values indicating a representative value of the lag in replication in a second period which includes the corresponding one of the plurality of target time points and which is longer than the first period; and outputting an alert relating to replication when, among the plurality of target time points, a counted number of target time points having a larger corresponding first value than a corresponding second value satisfies an anomaly detection condition.
(9) There is provided a program for causing a computer to execute processing of: acquiring a plurality of first values corresponding to a plurality of target time points included in a monitoring period respectively, each of the plurality of first values indicating a representative value of a lag in replication from a primary database to a secondary database in a first period including the corresponding one of the plurality of target time points; acquiring a plurality of second values corresponding to one of the plurality of target time points respectively, each of the plurality of second values indicating a representative value of the lag in replication in a second period which includes the corresponding one of the plurality of target time points and which is longer than the first period; and outputting an alert relating to replication when, among the plurality of target time points, a counted number of target time points having a larger corresponding first value than a corresponding second value satisfies an anomaly detection condition.

According to example embodiments in this disclosure, an anomaly in the system can be detected more appropriately.

### BRIEF DESCRIPTION OF THE DRAWINGS

FIG. 1 is a diagram for illustrating elements relating to an information processing system according to at least one embodiment of the present disclosure.

FIG. 2 is a diagram for illustrating database replication.

FIG. 3 is a block diagram for illustrating functions implemented by the information processing system.

FIG. 4 is a flowchart for illustrating an example of processing for collecting monitoring data.

FIG. 5 is a table for showing an example of data stored in a metrics database.

FIG. 6 is a flowchart for illustrating an example of processing for detecting an anomaly.

FIG. 7 is a graph for showing an example of a transition of a moving average of a lag.

### DETAILED DESCRIPTION

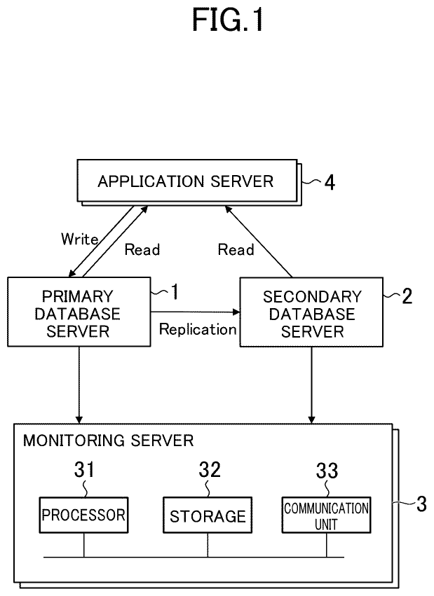

Now, at least one embodiment of the present disclosure is described with reference to the drawings. Redundant description of components denoted by the same reference symbols is omitted. FIG. 1 is a diagram for illustrating elements relating to an information processing system according to the at least one embodiment of the present disclosure. The information processing system may include a primary database server 1, a secondary database server 2, one or more monitoring servers 3, and one or more application servers 4. The primary database server 1, the secondary database server 2, the monitoring server(s) 3, and the application server(s) 4 are so-called server computers. Those servers communicate to and from each other via a network.

The primary database server 1 and the secondary database server 2 provide a service of a database that stores various types of data. In the following description, when the primary database server 1 and the secondary database server 2 are referred to without distinction, the primary database server 1 and the secondary database server 2 are simply referred to as “database server.” Replication processing is executed between the primary database server 1 and the secondary database server 2. As a result, the data in the secondary database server 2 can be synchronized with the primary database server 1. In the example of FIG. 1, the primary database server 1 can write to and read from a database, and the secondary database server 2 can only read from a database. The information processing system may include a plurality of primary database servers 1 which cooperate with each other to provide the database service, and a plurality of secondary database servers 2 which cooperate with each other to provide the database service.

Each monitoring server 3 includes one or more processors 31, one or more storages 32, and one or more communication units 33. The primary database server 1, the secondary database server 2, and each application server 4 may also include one or more processors 31, one or more storages 32, and one or more communication units 33. Those processors 31, storages 32, and communication units 33 may be implemented on one or more virtual Servers or container platforms.

Each processor 31 operates based on a program (also referred to as “instruction code”) stored in a storage 32. The processor(s) 31 control the communication unit(s) 33. Each processor 31 may include, for example, a central processing unit (CPU), and may further include a graphic processing unit (GPU) and a neural processing unit (NPU). The above-mentioned program may be provided through, for example, the Internet, or may be provided by being stored in a flash memory, a DVD-ROM, or another computer-readable storage medium.

Each storage 32 may be formed of a memory device such as a RAM or a flash memory, and an external storage device such as a hard disk drive (HDD) or a solid state drive (SSD). Storage(s) 32 may store the above-mentioned program. £ Storage(s) 32 may also store information and calculation results that are input from a processor 31 and a communication unit 33.

Each communication unit 33 is a communication interface, such as a network interface card, which communicates to and from other devices. Each communication unit 33 may include, for example, an integrated circuit, an antenna, and a communication terminal which implement a wireless LAN a wired LAN. Communication unit(s) 33 may input information received from another device to a processor 31 and a storage 32 via a network and transmit the information to another device under the control of the processor 31.

The hardware configurations of the monitoring servers 3 and other servers are not limited to the examples described above. For example, the monitoring servers 3 may each include a device for reading a computer-readable information storage medium (for example, an optical disc drive or a memory card slot) and a device for inputting and outputting data to and from an external device (for example, a USB port). The external device may be an input device or an output device.

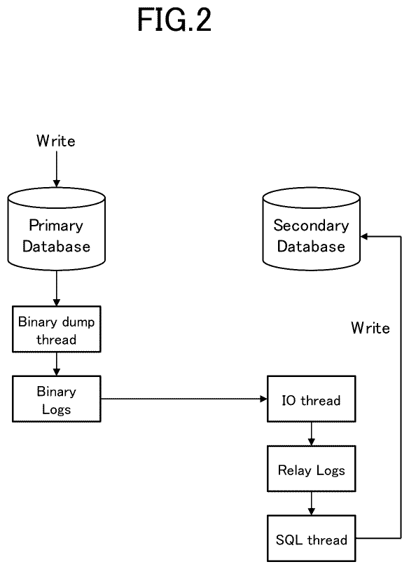

The replication processing between the primary database server 1 and the secondary database server 2 is now described further. FIG. 2 is a diagram for illustrating database replication. In FIG. 2, replication processing in MySQL (trademark) is illustrated.

In order to synchronize the data of the two database servers, when data is written (“Write”) to the database of the primary database server 1 (primary database) in response to a request from the application server 4, the secondary database server 2 writes (“Write”) the same data to the database of the secondary database server 2 (secondary database).

More specifically, when data is written to the primary database, the primary database server 1 may use log output processing (corresponding to “Binary dump thread” of FIG. 2) to output a log (corresponding to “Binary Logs” of FIG. 2) indicating a transaction which includes the writing of the data. The log indicating the transaction may include, for example, a timestamp indicating a write time of the data in the primary database, an item to be written, the written data, and a transaction ID identifying the transaction. Then, the secondary database server 2 may use log reception £ processing (corresponding to “IO thread” of FIG. 2) to receive the log, and output the log (corresponding to “Relay Logs” of FIG. 2) to the internal storage 32. The secondary database server 2 may use log-based write processing (corresponding to “SQL thread” of FIG. 2) to write the data to the secondary database.

Generally, replication is executed asynchronously, and hence a lag occurs between when data is written to the primary database and when the data is written to the secondary database. The time taken to write the data is, strictly speaking, the time executing a process referred to as “commit” the data to be executed. Committing in the primary database is performed, for example, immediately after a log (Binary Log) indicating that a transaction is output or immediately after the log is transmitted, and committing in the secondary database is performed in the write processing based on the log.

FIG. 2 and the above description are examples of so-called log shipping type replication, and, for example, other information such as more logical update information for each table or SQL may be transmitted and received instead of a log. Further, the database may be any database in which asynchronous replication is performed, and the database is not limited to a relational database. The primary database and the secondary database may be, for example, a NoSQL database such as MongoDB (trademark), or a distributed file management system such as Hadoop (trademark).

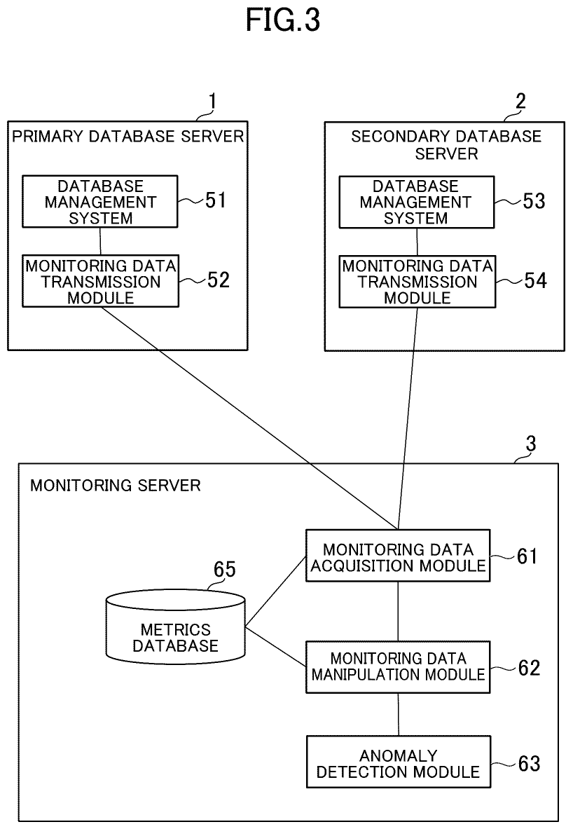

In the following description, description of a method of monitoring replication is given. FIG. 3 is a block diagram for illustrating functions implemented by the information processing system. The primary database server 1 may include, in terms of functions, a database management system 51 and a monitoring data transmission module 52. The secondary database server 2 may include, in terms of functions, a database management system 53 and a monitoring data transmission module 54. The database management system 51 and the monitoring data transmission module 52 may be implemented by the processor 31 included in the primary database server 1 executing a program (instruction code) stored in the storage 32. The database management system 53 and the monitoring data transmission module 54 may be implemented by the processor 31 included in the secondary database server 2 executing a program (instruction code) stored in the storage 32. The database management system 51 provides a primary database service. When the database management system 51 receives a data write request from an application server 4, the database management system 51 may perform processing (for example, “Binary dump thread” processing and transmission processing corresponding to “IO thread” of FIG. 2) for writing the data in the primary database and transmitting replication information (for example, “Binary Logs” of FIG. V to the secondary database server 2.

The database management system 53 may provide a secondary database service. The database management system 53 may receive replication information from the primary database server 1, and write the data written in the primary database to the secondary database. The database management systems 51 and 53 may be implemented by, for example, a relational database program. The database management systems 51 and 53 may be implemented by a NOSQL database or a distributed file management system program. The monitoring data transmission modules 52 and 54 are so-called monitoring agents. The monitoring data transmission module 52 collects a metric in the database management system 51, and transmits monitoring data including the metric to the monitoring server 3. The monitoring data transmission module 54 collects a metric in the database management system 53, and transmits monitoring data including the metric to the monitoring server 3. The metric is one or more indicators indicating a status of the server or the service, and includes information indicating a lag in replication. The lag in replication is the time between when data is written to the primary database and when that data is written to the secondary database. When the database management systems 51 and 53 are capable of collecting the metric from outside, the monitoring data transmission modules 52 and 54 may be arranged in the monitoring server 3.

Each of the plurality of monitoring servers 3 implements a monitoring data acquisition module 61, a monitoring data manipulation module 62, an anomaly detection module 63, and a metrics database 65.

The monitoring data acquisition module 61 may receive monitoring data from the monitoring data transmission modules 52 and 54, and store the metric included in the monitoring data in the metrics database 65 together with the time at which the metric is collected. The metrics database 65 may be mainly configured from the storage 32, and store collected metrics.

The monitoring data manipulation module 62 may extract a metric which satisfies a condition from the metrics database 65, process (for example, aggregates) the extracted metric, and output the processed result.

Regarding replication, the monitoring data manipulation module 62 may perform the following processing. The monitoring data manipulation module 62 may calculate a plurality of first values corresponding to a plurality of target time points included in a monitoring period respectively, each first value indicating a representative value of a lag in replication in a first period including the corresponding target time point. Here, the monitoring period indicates the duration for which monitoring-related aggregation is performed, and is a duration in which a plurality of target time points (for example, 10 target time points) which are included in the monitoring period (for example, 10 minutes) which exist at predetermined intervals (for example, 1 minute) are aggregated. The representative value may be a moving average (for example, a simple moving average) of the lag in replication in a first period (1 minute) including the corresponding target time point. The target time point is closer to the end of the first period that includes the target time point than to the start of the first period. For example, the target time point may be at the end of the first period.

Further, the monitoring data manipulation module 62 may calculate a plurality of second values corresponding to the plurality of target time points respectively, each second value indicating a representative value of the lag in replication in a second period that includes the corresponding target time point. Here, the second period is longer than the first period (for example, is 5 minutes) , and the representative value may be a moving average of the lag in replication in the second period (5 minutes) including the corresponding target time point. The target time point is closer to the end of the second period that includes the target time point than to the start of the second period. For example, the target time point may be at the end of the second period. The length of the first period and the length of the second period are each determined in advance.

The monitoring data manipulation module 62 may calculate a number obtained by counting the target time points having a larger corresponding first value than a corresponding second value among the plurality of target time points.

The monitoring data acquisition module 61 and the monitoring data manipulation module 62 may be implemented by a well-known monitoring tool such as Prometheus. When Prometheus is used, the monitoring data transmission modules 52 and 54 are also referred to as “exporters.”

The anomaly detection module 63 may output an alert when the processed metric satisfies an anomaly detection condition. The anomaly detection module 63 may output an alert relating to replication when the counted number of target time points having a larger corresponding first value than a corresponding second value satisfies the anomaly detection condition. The anomaly detection condition may be a condition that the counted number is larger than a threshold value. The threshold value may be determined by multiplying the number of target time points included in the monitoring period by a predetermined ratio (for example, 70%). The anomaly detection module 63 may be implemented by using a well-known tool such as Grafana (trademark) or Alert Manager to execute a script, or may be implemented by using another monitoring tool to execute a script.

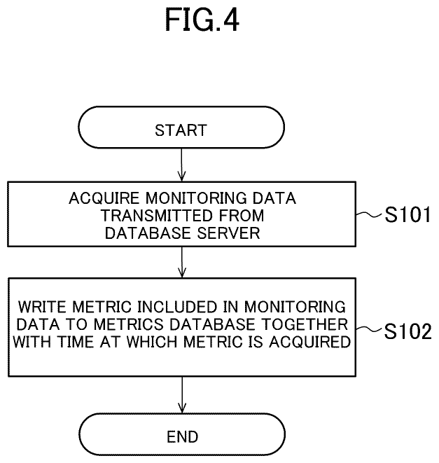

The processing executed by the monitoring server 3 is now described further. FIG. 4 is a flowchart for illustrating an example of processing for collecting monitoring data. The processing is executed each time monitoring data is received from the database server. The processing illustrated in FIG. 4 may be executed at regular intervals.

First, the monitoring data acquisition module 61 may acquire monitoring data transmitted from the database server (S101). Then, the monitoring data acquisition module 61 may write the metric included in the monitoring data to the metrics database 65 together with the time at which the metric is acquired (S102).

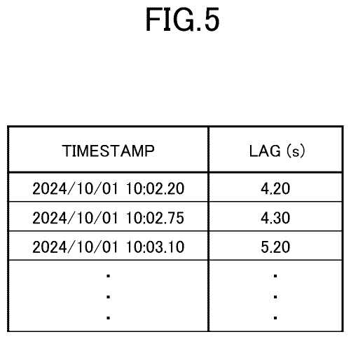

FIG. 5 is a table for showing an example of data stored in the metrics database 65. In the example of FIG. 5, there is shown an example of data given when the database server transmits monitoring data each time data is written to the database, and the monitoring data includes a timestamp and information indicating the lag in replication as a metric. The information indicating the lag in replication is stored in association with the timestamp. The information indicating the lag in replication may be the time of the lag of replication calculated by the database management system 53. The timestamp may be the time at which the lag in replication is acquired from the database management system 53.

Here, the time of the lag of replication may be the difference between the time at which data included in a transaction in the secondary database is written and the time at which the data included in the same transaction is written to the primary database. When the log transmitted from the primary database to the secondary database includes the time at which the data is written to the primary database, it is easy for the database management system 53 to Calculate the lag in replication.

The information indicating the lag in replication may be the time at which data included in a transaction in the secondary database is written, and the time at which the data included in the same transaction is written to the primary database.

Here, the secondary database server 2 may transmit, as the monitoring data, a timestamp, a transaction ID of the transaction, a write time of the transaction, and the time of the lag of replication, and the monitoring data acquisition module 61 may acquire the monitoring data and store the acquired monitoring data in the metrics database 65 as a metric. Further, the primary database server 1 may transmit, as the monitoring data, a timestamp, a transaction ID of the transaction, and a write time of the transaction, and the monitoring data acquisition module 61 may acquire the monitoring data and store the acquired monitoring data in the metrics database 65 as a metric.

In this case, the lag in replication can be calculated by also taking into consideration the data that has not yet been written to the secondary database. Specifically, the monitoring data acquisition module 61 may calculate the lag in replication by executing the following processing periodically (at a cycle equal to or less than the first period, for example, every 30 seconds), and store the calculated lag in replication in the metrics database 65.

First, the monitoring data acquisition module 61 may acquire from the metrics database 65 the transaction ID of the latest write to the secondary database. Next, the monitoring data acquisition module 61 may acquire the write time of the write next to the write specified by the transaction ID for the primary database from the metrics database 65, and calculate the difference between the write time and the current time. When the calculated difference is larger than the latest lag transmitted from the secondary database server 2 and stored in the metrics database 65, the monitoring data acquisition module 61 may store the difference in the metrics database 65 as the lag in replication at the current time. As a result, the lag can be detected even when replication has almost stopped due to a network trouble, for example.

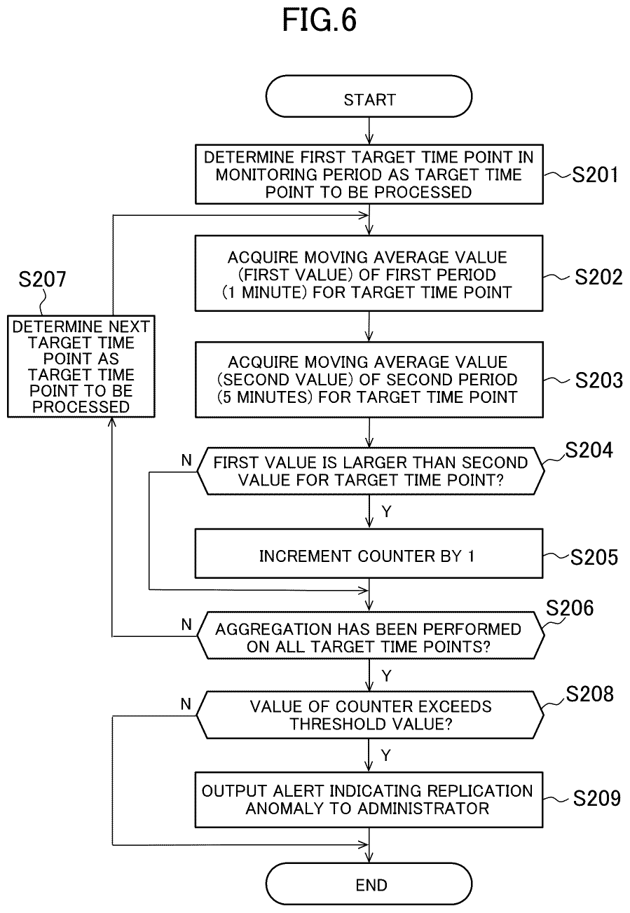

Next, processing for detecting an anomaly based on the information stored in the metrics database 65 is described. FIG. 6 is a flowchart for illustrating an example of processing for detecting an anomaly. The flow illustrated in FIG. 6 may be executed every predetermined repeat period (for example, every 10 minutes). The processing illustrated in FIG. 6 (particularly S201 to S206) may be executed, for example, by the anomaly detection module 63 which is executing a set script (program) outputting an instruction relating to aggregation to the monitoring data manipulation module 62, and the monitoring data manipulation module 62 performing processing relating to aggregation based on the instruction.

In S201 to S206, the monitoring data manipulation module 62 calculates a first value and a second value for each of a plurality of target time points in the monitoring period, and further executes aggregation processing for counting the number of target time points having a larger corresponding first value than a corresponding second value among the plurality of target time points. It is assumed that before the processing step of S201, the monitoring period is set to a period having a predetermined length up to the start time of the processing of FIG. 6, and that the plurality of target time points included in the period are determined. The monitoring period may be defined by the number of target time points included in the monitoring period. Moreover, in place of the processing start time, a time offset in the past by a predetermined time within the first period may be used.

In the aggregation processing, first, the monitoring data manipulation module 62 determines the first target time point in the monitoring period as the target time point to be processed (S201). The plurality of target time points may be arranged in chronological order or may be arranged based on other criteria.

The monitoring data manipulation module 62 may acquire, as a first value, the average of values of the lag in replication in the first period for the target time point to be processed (S202). In the example of FIG. 6, the first period is one minute up to the target time point. The monitoring data manipulation module 62 calculates the average of the lag in replication stored in the metrics database 65 in association with the timestamp belonging to the first period. This average corresponds to a moving average.

The monitoring data manipulation module 62 acquires, as a second value, the average of values of the lag in replication in the second period for the target time point to be processed (S203). In the example of FIG. 6, the second period is 5 minutes up to the target time point. The monitoring data manipulation module 62 calculates the average of the lag in replication stored in the metrics database 65 in association with the timestamp belonging to the second period. This average corresponds to a moving average.

The monitoring data manipulation module 62 may determine whether or not the first value is larger than the second value for the target time point to be processed (S204). When the first value is larger than the second value (“Y” in S204), the monitoring data manipulation module 62 may increment a counter by 1 (S205). When the first value is equal to or less than the second value (“N”in S204), S205 is skipped.

When aggregation (processing S of from S202 to S204) has not been performed on all target time points (“N” in S206), the monitoring data manipulation module 62 may determine the next target time point among the plurality of target time points as the target time point to be processed (S207), and the processing S from S202 and the subsequent S are repeated.

When all target time points have been aggregated (“Y” in S206), the anomaly detection module 63 determines whether or not the value of the counter exceeds a threshold value (S208). The threshold value may be a value obtained by multiplying the number of the plurality of target time points by a predetermined ratio. The predetermined ratio is larger than 50%, for example, 70%.

When the value of the counter exceeds the threshold value in S208 (“Y” in S208), the anomaly detection module 63 outputs an alert indicating a replication anomaly to the administrator (S209). The anomaly detection module 63 may transmit the alert by email, by chat service such as Slack (trademark), by SMS/phone, or by push notification to a smartphone. The anomaly detection module 63 may output an alert to the screen of a display device.

When the value of the counter does not exceed the threshold value (“N” in S208), the processing illustrated in FIG. 6 ends. In addition, in S208, the anomaly detection module 63 may determine whether or not a value obtained by dividing the value of the counter by the number of the plurality of target time points exceeds a predetermined ratio. When the predetermined ratio is exceeded, the processing step of S209 is executed.

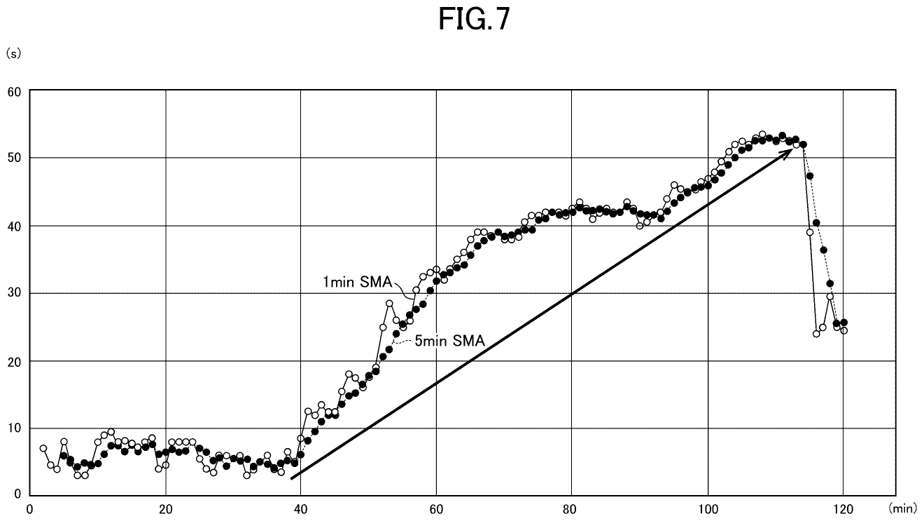

FIG. 7 is a graph for showing an example of a transition of a moving average of a lag. In the graph shown in FIG. 7, the vertical axis is a lag(s), and the horizontal axis is an elapsed time from the start of monitoring. The elapsed time corresponds to the target time point. Further, the value of the markers connected by the solid line indicates the 1-minute simple moving average of the lag, and the value of the markers connected by the broken line indicates the 5-minute simple moving average of the lag.

In FIG. 7, an arrow pointing toward the upper right is drawn in the section in which the elapsed time is from about 37 minutes to about 113 minutes. In this section, the lag is trending upward. When the lag is trending upward, the 1-minute moving average increases faster, and tends to exceed the 5-minute moving average. In particular, when the target time point is located in the latter half of the period of the moving average, the 1-minute moving average tends to exceed the 5-minute moving average. In the example of FIG. 7, a replication anomaly can be detected within 10 minutes after a significant increase in the lag.

The information processing system in at least one embodiment can detect an increase in lag earlier than a method of determining whether the absolute value of a measured value of a lag or the like exceeds a threshold value. Through detecting an anomaly early, the administrator can respond quickly. Moreover, during the period in which the lag in replication is increasing, anomalies may be continuously detected. As a result, the administrator may be continuously notified of alerts, and hence there is reduced risk of the administrator forgetting to take action.

Further, in at least one embodiment, the threshold value relates to the ratio of the 1-minute moving average exceeding the 5-minute moving average, and has nothing to do with the absolute value of the moving average. It is not required to determine the threshold value experimentally. Thus, the monitoring server 3 in at least one embodiment can be easily applied even when there are large differences in the individual environment, such as the database server configuration or the network. For example, the monitoring server 3 in at least one embodiment can be applied even when the type of the databases executed by the database management systems 51 and 53 is not a relational database (for example, NoSQL), and can even be applied when network latency is significantly different.

Further, an increase in lag can be detected with high accuracy, and hence it is possible to prevent the burden of erroneous detections on the administrator and to prevent a delay in responding due to erroneous detections.

While there have been described what are at present considered to be certain embodiments of the disclosure, it will be understood that various modifications may be made thereto, and it is intended that the appended claims cover all such modifications as fall within the true spirit and scope of the disclosure.

1. A monitoring system, comprising:
at least one processor; and
at least one memory device that stores a plurality of instructions which, when executed by the at least one processor, causes the at least one processor to:
acquire, each time data is written to a primary database, a first timestamp indicating a time of the writing;
acquire, each time data is written to a secondary database, a second timestamp indicating a time of the writing:
obtain a lag in replication based on the first timestamp and the second timestamp;
acquire a plurality of first values corresponding to a plurality of target time points included in a monitoring period respectively, each of the plurality of first values indicating a moving average of the lag in replication from the primary database to the secondary database in a first period including the corresponding one of the plurality of target time points;
acquire a plurality of second values corresponding to the plurality of target time points respectively, each of the plurality of second values indicating a moving average of the lag in replication in a second period which includes the corresponding one of the plurality of target time points and which is longer than the first period; and
output an alert relating to replication when, among the plurality of target time points, a counted number of target time points having a larger corresponding first value than a corresponding second value satisfies an anomaly detection condition,
wherein the acquisition of the plurality of first values and the acquisition of the plurality of second values are executed every predetermined repeat period.

2. (canceled)

3. The monitoring system according to claim 1, wherein the lag in replication is a time period from when information is written to the primary database until the information is written to the secondary database.

4. The monitoring system according to claim 1, wherein each of the plurality of target time points is closer to an end of a corresponding second period than to a start of the corresponding second period.

5. The monitoring system according to claim 1, wherein the plurality of instructions cause the at least one processor to output the alert relating to replication when the counted number of the target time points is larger than a threshold value corresponding to the number of target time points.

6. The monitoring system according to claim 5, wherein the threshold value is determined by multiplying the number of the plurality of target time points by a predetermined ratio.

7. The monitoring system according to claim 1, wherein the plurality of instructions cause the at least one processor to output the alert relating to replication to an administrator when the anomaly detection condition is satisfied.

8. A monitoring method, comprising:
acquiring with at least one processor operating with a memory device in a system, each time data is written to a primary database, a first timestamp indicating a time of the writing;
acquiring, with the at least one processor operating with the memory device in the system, each time data is written to a secondary database, a second timestamp indicating a time of the writing;
obtaining, with the at least one processor operating with the memory device in the system a lag in replication based on the first timestamp and the second timestamp;
acquiring, with the at least one processor operating with the memory device in the system, a plurality of first values corresponding to a plurality of target time points included in a monitoring period respectively, each of the plurality of first values indicating a moving average of the lag in replication from the primary database to the secondary database in a first period including the corresponding one of the plurality of target time points;
acquiring, with the at least one processor operating with the memory device in the system, a plurality of second values corresponding to the plurality of target time points respectively, each of the plurality of second values indicating a moving average of the lag in replication in a second period which includes the corresponding one of the plurality of target time points and which is longer than the first period; and
outputting, with the at least one processor operating with the memory device in the system, an alert relating to replication when, among the plurality of target time points, a counted number of target time points having a larger corresponding first value than a corresponding second value satisfies an anomaly detection condition,
wherein the acquisition of the plurality of first values and the acquisition of the plurality of second values are executed every predetermined repeat period.

9. A non-transitory computer readable storage medium storing a plurality of instructions, wherein when executed by at least one processor, the plurality of instructions cause the at least one processor to:
acquire, each time data is written to a primary database, a first timestamp indicating a time of the writing;
acquire, each time data is written to a secondary database, a second timestamp indicating a time of the writing:
obtain a lag in replication based on the first timestamp and the second timestamp;
acquire a plurality of first values corresponding to a plurality of target time points included in a monitoring period respectively, each of the plurality of first values indicating a moving average of the lag in replication from the primary database to then secondary database in a first period including the corresponding one of the plurality of target time points;
acquire a plurality of second values corresponding to the plurality of target time points respectively, each of the plurality of second values indicating a moving average of the lag in replication in a second period which includes the corresponding one of the plurality of target time points and which is longer than the first period; and
output an alert relating to replication when, among the plurality of target time points, a counted number of target time points having a larger corresponding first value than a corresponding second value satisfies an anomaly detection condition,
wherein the acquisition of the plurality of first values and the acquisition of the plurality of second values are executed every predetermined repeat period.
